(19) United States
(12) Patent Application Publication
(10) Pub. No.: US 2007/0057772 A1
(43) Pub. Date: Mar. 15, 2007

(54) Hybrid SAW/BAW sensor

(75) Inventor: James ZT Liu, Belvidere, IL (US)

Correspondence Address: Intellectual Property;Honeywell International Inc., 101 Columbia Rd., P.O. Box 2245, Morristown, NJ, 07962, US

(73) Assignee: Honeywell International Inc.

(21) Appl. No.: 11/224,446

(22) Filed: Sep. 9, 2005

(51) Int. Cl. H04Q 5/22

(52) U.S. Cl. 340/10.4

(57) ABSTRACT

A SAW/BAW hybrid sensor is a sensor that combines the ease of interfacing with a higher frequency of SAW device and the response, precision, ease of use with liquid applications and dynamic range of a BAW sensor. The SAW device can condition an interrogation signal before passing it to the BAW sensor. For example, the SAW device can act as an impedance matcher or a frequency shifter. The hybrid sensor can be created by connecting the electrodes of a BAW sensor to a SAW device transducer. The hybrid sensor can be interrogated via any of the common interrogation circuits such as a grid dip oscillator or a RADAR type interrogation system.

### TECHNICAL FIELD

Embodiments relate to the field of sensing circuits. Embodiments also relate to surface acoustic wave devices and bulk acoustic wave sensors. Embodiments additionally relate to using a bulk acoustic wave sensor as load to a surface acoustic wave device.

### BACKGROUND

Acoustic wave devices often have one or two transducers arranged on a piezoelectric substrate. A transducer can convert an electrical input signal into an acoustic signal. The acoustic wave device can then alter the acoustic signal as it propagates through, or along, the substrate. A transducer can also convert the acoustic signal into an electrical signal. One common use of acoustic wave devices is conditioning or filtering signals, such as filtering the electrical signal received by a cellular telephone, because acoustic wave devices can be extremely good and inexpensive signal filters.

Acoustic wave devices are also used as sensors. The piezoelectric substrate is sensitive to environmental conditions. It can expand or contract with the temperature. Pressure can cause it to flex. Some chemical sensors are based on acoustic wave devices such that exposure to a chemical, such as water or alcohol, can introduce mass-loading effect. Mass-loading to the substrate of an acoustic wave device can change its acoustic properties. The changing acoustic properties can affect the acoustic signals which become electrical signals at the transducers. As such, acoustic wave devices have been used to measure temperature, pressure, chemical densities, and other environmental properties.

One type of acoustic wave device is a surface acoustic wave device (SAW) in which the acoustic waves propagate along the surface of the substrate. A common variety of SAW has an input transducer, an output transducer, and a substrate. An input electrical signal enters the input transducer, becomes an acoustic signal, and travels over the substrate surface to the output transducer. The acoustic signal can be transformed by the substrate as it travels over the substrate surface. The output transducer then converts the acoustic signal into an output electrical signal. Essentially, the SAW transforms the input electrical signal into the output electrical signal.

A SAW device can be a signal filter that selectively transmits certain frequencies. A SAW device can be a frequency converter that converts the input signal into an output signal at a different frequency. A SAW device can be an impedance matcher that accepts a signal from a signal source and conditions it. Those skilled in the arts of electronics, radio and signaling are familiar with the techniques of filtering, frequency conversion, and impendence matching.

Another type of acoustic wave device is a bulk acoustic wave device (BAW) in which the acoustic signal travels through the substrate. BAW devices can be used in applications similar to those of SAW and other acoustic wave devices. When used as sensors, BAW components have higher effective sensitivity, resolution, ease of use with liquid applications, and dynamic range than SAWs. However, SAWs typically have a larger bandwidth. Furthermore, some SAWs can receive an electromagnetic signal, such as a radio wave, directly into the input transducer. Generally, it can be far easier to put signals into and get signals out of a SAW than a BAW.

A sensor can not be advantageously employed unless an interrogation circuit is also employed. An interrogation circuit is a circuit that creates an interrogation signal that is passed to the sensor. The sensor then returns a response signal or affects the interrogation signal in some way. For example, an electronic thermometer can accept an interrogation signal comprising power and ground while returning a voltage proportional to the temperature as a response signal. Alternatively, a material that changes its electrical resistance can be used as a temperature sensor. The interrogation signal can be power and ground voltages while the current passing through the circuit is the response signal.

FIG. 7, labeled as prior art, illustrates an inductively coupled interrogation circuit 201. A function generator 701 can produce a signal. One such signal is a repeating voltage ramp. Those skilled in the arts of electronics or signaling often call this a saw tooth signal. The saw tooth signal can be passed to a voltage controlled oscillator (VCO) 702. A VCO 702 produces a signal with a frequency dependent on an input voltage. Passing a saw tooth signal to the VCO 702 causes the VCO 702 to produce an interrogation signal that repeatedly sweeps through a range of frequencies. The interrogation signal is passed to an inductor 501, a grid dip oscillator (GDO) 703, and a phase locked loop (PLL) 704. The inductor 501 can inductively couple the interrogation signal into an inductive load (not shown).

The efficiency with which the interrogation signal is coupled into an inductive load depends on the inductive load and the interrogation signal frequency. Many circuits, including inductive loads, have a fundamental frequency. When the interrogation signal frequency matches the fundamental frequency, the coupling is maximized. As the interrogation signal sweeps through a frequency range, the fundamental frequency can be detected by the GDO 703 because the voltage across the inductor 501 drops to a minimum value at the inductive load's fundamental frequency. The GDO 703 signals the PLL 704 at the fundamental frequency. A PLL 704 is an oscillator that can lock onto and follow a source signal. As such, the PLL 704 locks onto and follows the interrogation signal. When signaled by the GDO 703, however, the PLL 704 can stop following the interrogation signal and remain producing a locked signal at the inductive load's fundamental frequency. The locked signal is passed to a frequency counter 705.

The system of FIG. 7 illustrates an interrogation circuit that can measure the fundamental frequency of an inductive load. Similar interrogation circuits are disclosed in U.S. Pat. No. 3,092,806 and U.S. Pat. No. 3,906,340. U.S. Pat. No. 3,092,806 and U.S. Pat. No. 3,906,340 are incorporated by reference into this document.

Aspects of the embodiments directly address the shortcoming of current technology by combining the advantageous properties of SAW and BAW devices into a hybrid sensor.

### BRIEF SUMMARY

It is therefore an aspect of the embodiments to connect a BAW sensor to the output transducer of a SAW device such that an interrogation signal introduced to the SAW input transducer is conditioned for use as a BAW input signal. The BAW sensor acts as a load on the SAW output transducer which then introduces a return acoustic wave to the SAW substrate that propagates to the first transducer where a return electrical signal appears.

It is an aspect of an embodiment to connect an interrogation circuit directly to the SAW input transducer such that the interrogation circuit can produce an interrogation signal that is passed directly to the SAW device via an electrical connection. As such, the interrogation circuit sees a sensor with the signal properties of a SAW device but the sensing properties of a BAW sensor. The interrogation circuit can include a grid dip oscillator. In alternative embodiments, the interrogation signal can be wirelessly passed to the SAW device input transducer using electromagnetic waves or inductive coupling.

It is another aspect of an embodiment to transmit the interrogation signal to the SAW input transducer. The SAW input transducer can directly receive the transmitted interrogation signal or use an antenna. Furthermore, the interrogation circuit and the SAW can be inductively coupled.

It is also another aspect of an embodiment to use the SAW device as a frequency converter. The interrogation signal can have a first frequency. The SAW can convert the interrogation signal to an electrical signal having a second frequency which is passed to the BAW sensor resulting in a response returned via the SAW output transducer and SAW substrate to the SAW input transducer.

It is a further aspect of an embodiment to use the SAW device as an impedance matcher.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a SAW/BAW hybrid sensor in accordance with an aspect of an embodiment;

FIG. 2 illustrates an interrogation circuit electrically connected to a hybrid sensor in accordance with an aspect of an embodiment;

FIG. 3 illustrates a SAW/BAW hybrid sensor with an antenna in accordance with an aspect of an embodiment;

FIG. 4 illustrates an interrogation circuit wirelessly coupled to a hybrid sensor in accordance with an aspect of an embodiment;

FIG. 5 illustrates an interrogation circuit inductively coupled to a hybrid sensor in accordance with an aspect of an embodiment;

FIG. 6 illustrates a high level flow diagram of using a SAW/BAW hybrid sensor in accordance with an aspect of an embodiment; and

FIG. 7, labeled as prior art, illustrates an inductively coupled interrogation circuit.

### DETAILED DESCRIPTION

The particular values and configurations discussed in these non-limiting examples can be varied and are cited merely to illustrate at least one embodiment and are not intended to limit the scope thereof.

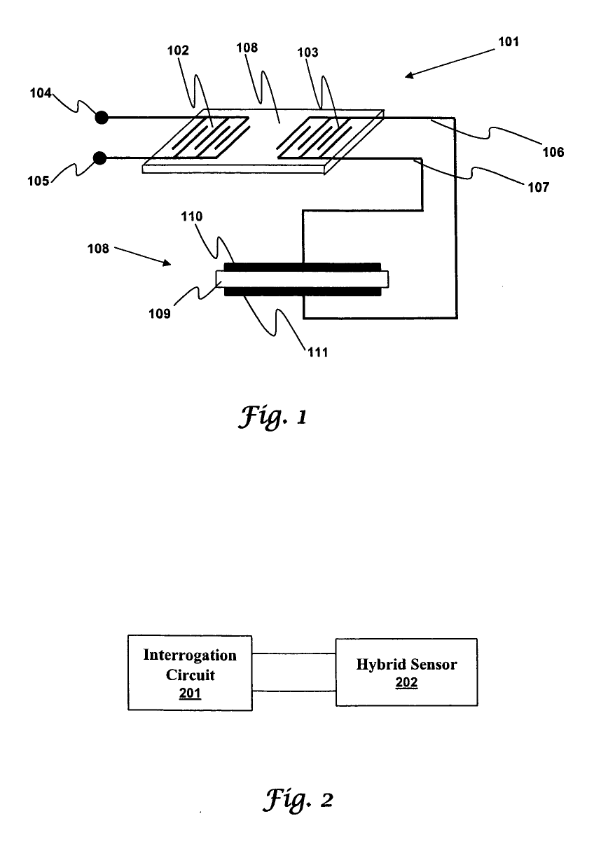

FIG. 1 illustrates a SAW/BAW hybrid sensor in accordance with an aspect of an embodiment. A SAW device 101 has an input transducer 102 and an output transducer 103 mounted on a substrate 108. The input transducer 102 has a first input node 104 and a second input node 105 through which electrical signals can be passed into and out of the input transducer 102. The output transducer 103 has a first output node 106 and a second output node 107. A BAW sensor 108 has a first electrode 110 and second electrode 111 mounted on a substrate 109. The first output node 106 is electrically connected to the first electrode 110. The second output node 107 is electrically connected to the second electrode.

FIG. 2 illustrates an interrogation circuit 201 electrically connected to a hybrid sensor 202 in accordance with an aspect of an embodiment. An interrogation circuit 201 can be any of the interrogation circuits known to those practiced in the arts of sensing or acoustic wave devices. The hybrid sensor 202 is a BAW/SAW hybrid sensor as discussed above.

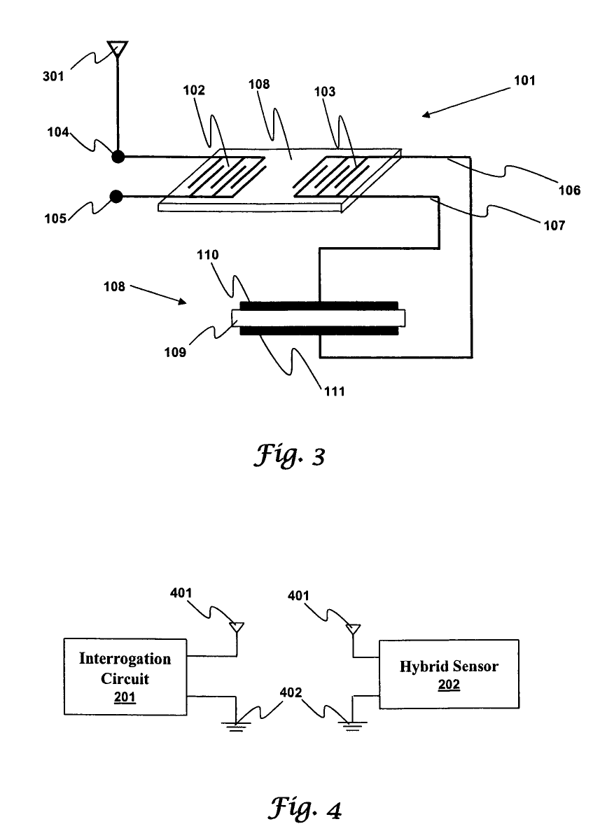

FIG. 3 illustrates a SAW/BAW hybrid sensor with an antenna 301 in accordance with an aspect of an embodiment. The only difference between FIG. 1 and FIG. 3 is the antenna 301. The antenna 301 can be used to couple a radio frequency interrogation signal into the SAW/BAW hybrid sensor.

FIG. 4 illustrates an interrogation circuit 202 wirelessly coupled to a hybrid sensor 202 in accordance with an aspect of an embodiment. The difference between FIG. 4 and FIG. 1 is that the circuits in FIG. 4 communicate via radio waves instead of using a direct electrical connection. The lower connections of each circuit go to ground 402. The upper connections go to antennas 401.

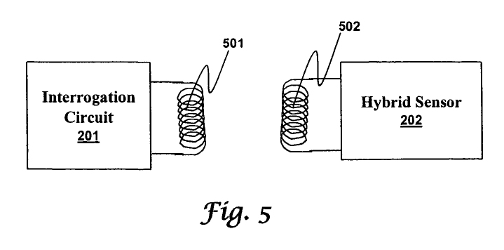

FIG. 5 illustrates an interrogation circuit 201 inductively coupled to a hybrid sensor 202 in accordance with an aspect of an embodiment. A first inductor 501 is connected to the interrogation circuit 201 and a second inductor 502 is electrically connected to the hybrid sensor 202. Signals can be passed between the inductors via inductive coupling.

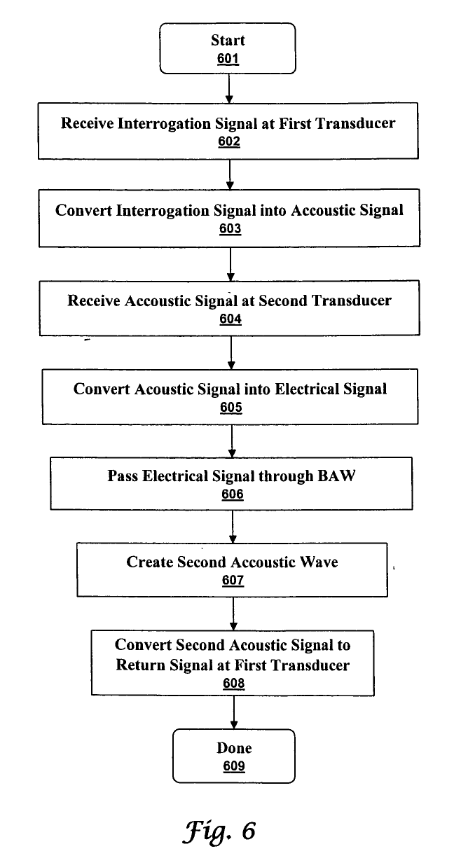

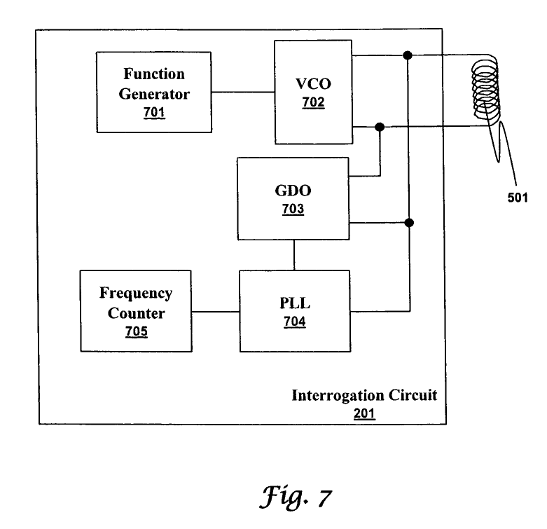

FIG. 6 illustrates a high level flow diagram of using a SAW/BAW hybrid sensor in accordance with an aspect of an embodiment. After the start 601, the interrogation signal is received at the input transducer 602 of a SAW device where it is converted into an acoustic signal 603. The SAW output transducer receives the acoustic signal 604 and converts it into an electrical signal 605. The electrical signal is passed through the BAW 606 which acts as a circuit load on the SAW output transducer which creates a second acoustic wave 607. The input transducer converts the second acoustic signal into the return signal 608 which is an electrical signal that can be measured and interpreted by an interrogation circuit. The process is then done 609.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A system comprising:
a surface acoustic wave device comprising a first piezoelectric substrate, a first transducer, and a second transducer with each transducer comprising a first node and a second node; and
a bulk acoustic wave device comprising a second piezoelectric substrate, a first electrode and a second electrode wherein the first node of the second transducer is electrically connected to the first electrode and the second node of the second transducer is electrically connected to second electrode.

2. The system of claim 1 further comprising an interrogation circuit connected to the first transducer.

3. The system of claim 2 wherein the interrogation circuit comprises a grid dip oscillator.

4. The system of claim 1 further comprising an impedance matcher comprising the second transducer that matches the first transducer's input impedance to the bulk acoustic wave device's input impedance.

5. The system of claim 1 wherein the surface acoustic wave device converts a first frequency at the first transducer to a second frequency at the second transducer and wherein the surface acoustic wave device converts the second frequency at the second transducer to the first frequency at the first transducer.

6. A system comprising:
an input comprising wire and a first terminal;
a surface acoustic wave device comprising a first piezoelectric substrate, a first transducer, and a second transducer wherein each transducer comprises a first node and a second node and wherein the first node of the first transducer is electrically connected to the first terminal; and
a bulk acoustic wave device comprising a second piezoelectric substrate, a first electrode and a second electrode wherein the first node of the second transducer is electrically connected to the first electrode and the second node of the second transducer is electrically connected to second electrode.

7. The system of claim 6 further comprising an interrogation circuit wirelessly coupled to the input.

8. The system of claim 7 further comprising an antenna that wirelessly couples the interrogation circuit to the input.

9. The system of claim 6 wherein the input further comprises a second terminal wherein the second node of the first transducer is electrically connected to the second terminal.

10. The system of claim 9 wherein the input is an inductor.

11. The system of claim 10 further comprising an interrogation circuit wirelessly coupled to the inductor.

12. The system of claim 11 further comprising a second inductor connected to the interrogation circuit that inductively couples the interrogation circuit to the input.

13. A method, comprising:
receiving an interrogation signal at a first transducer of a surface acoustic wave device comprising the first transducer, a second transducer, and a piezoelectric substrate;
converting the interrogation signal into an acoustic signal that travels along the piezoelectric substrate to the second substrate where it is converted to an electrical signal;
passing the electrical signal through a bulk acoustic wave device connected to the second transducer such that the bulk acoustic wave device acts as an electrical load on the second transducer and such that a second acoustic signal is returned from the second transducer to the first transducer; and
converting the second acoustic signal to a return signal at the first transducer.

14. The method of claim 13 further comprising causing the frequency of the electric signal to differ from that of the interrogation frequency.

15. The method of claim 13 further comprising causing the frequency of the return signal to differ from that of the electric signal.

16. The method of claim 13 further comprising producing an interrogation signal with an interrogation circuit and using wire to connect the interrogation circuit to the first transducer.

17. The method of claim 13 further comprising producing an interrogation signal with an interrogation circuit and wirelessly transmitting the interrogation signal to an antenna electrically connected to the first transducer.

18. The method of claim 13 further comprising inductively coupling an interrogation circuit to the first transducer.
